(19) United States
(12) Patent Application Publication
(10) Pub. No.: US 2005/0010558 A1
(43) Pub. Date: Jan. 13, 2005

(54) Data query system load balancing

(75) Inventors: Richard D. Dettinger, Rochester, MN (US); Frederick A. Kulack, Rochester, MN (US); Richard J. Stevens, Mantorville, MN (US); Eric W. Will, Oronoco, MN (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/618,410

(22) Filed: Jul. 11, 2003

(51) Int. Cl. G06F 17/30

(52) U.S. Cl. 707/3

(57) ABSTRACT

A system, method and article of manufacture for query execution management in a data processing system and more particularly for scheduling execution of queries against one or more databases in a data processing system. One embodiment provides a method for managing query execution in a data processing system. The method comprises providing at least one query execution schedule configured to schedule specific queries against a database in the data processing system, receiving a query against the database, and managing execution of the received query on the basis of the at least one query execution schedule.

### CROSS-RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to query execution management in a data processing system and more particularly to scheduling execution of queries against one or more databases in a data processing system.

2. Description of the Related Art

Complex computing systems may be used to support a variety of applications. One common use is the maintenance of large databases, from which information may be obtained. Large databases usually support some form of database query for obtaining information which is extracted from selected database fields and records. Such queries can consume significant system resources, particularly processor resources. In general, a query involves retrieving and examining records in a database according to some search strategy.

For instance, a large data warehouse can run in a production environment for its intended use in the day-by-day business of a company. The production environment may support query requests submitted to the large data warehouse. The data warehouse may be implemented in a federated data environment, i.e., a distributed environment having distributed databases in which a given query may be run against multiple databases. Such a production environment often has to support a wide range of queries representing a broad distribution of computing workload, i.e., the amount of time and computing resources required to fulfill each received query. At the same time, there may be other computing workload competing for the same computing resources. By way of example, in a medical environment, patient appointment scheduling, lab test result management systems and ad hoc biomedical research may all try to access the same clinical database concurrently for obtaining patient demographic and lab test result data. The other computing workload may or may not be viewed as having higher priority than query workload relating to specific data query requests. Furthermore, the relative priority of query workloads in relation to other workloads may change over time (e.g., vary by time-of-day, day-of-week or time-of-year). Additionally, there may be issues relative to the accessibility of data involved in query requests. In particular, with federated data environments, certain data source components of a query may be offline and unavailable on a time-by-time basis.

One difficulty when dealing with query requests against large data warehouses in federated data environments is to guarantee an acceptable turnaround for small, frequent query requests while allowing large complex queries to run against the same data. Another difficulty is to support execution of exploratory, research style complex queries against data in the data warehouse that is needed for day-to-day operations. This applies, for example, in a medical environment where a medical researcher needs to access data that is used to drive day-to-day applications involved in daily medical practice, such as appointments, lab test tracking and diagnostic systems. Still another difficulty is to guarantee successful completion of a query. This applies especially to queries that are long running and involve multiple databases in a federated data environment. As the multiple databases may not be available during the complete time interval when the queries are running, execution of a query may fail due to the unavailability of a required database.

Accordingly, a number of techniques have been employed to deal with these difficulties. For instance, multiple copies of data in the data warehouse may be maintained to satisfy different computing workloads on the same data separately. Thus, the effect that one set of applications using the data may have on another set of applications using the same data can be isolated. In the above example, one copy of data may accordingly be provided for medical searchers and another copy for the day-to-day applications involved in the daily medical practice. Furthermore, especially in federated data environments, a local copy of data may be maintained if the data is unavailable during certain periods of time. In other words, in the case where remote data is often unavailable, a local copy of the data may be created that is more available than the remote data it is based on. Furthermore, additional hardware may be allocated to ensure that the peak data access demand periods are satisfied with adequate response times. Moreover, some large database applications have query optimizers which construct search strategies. An optimizer is an application program which is intended to construct a near optimal search strategy for a given set of search parameters, according to known characteristics of the database, the system on which the search strategy will be executed, and/or optional user specified optimization goals. Often, a query (search strategy) constructed by a query optimizer can be saved and re-used again and again. But not all strategies are equal and various factors may affect the choice of an optimum search strategy. However, in general such search strategies merely determine an optimized use of available hardware/software components to execute respective queries.

A major drawback of these approaches is that they generally lead to less than optimal utilization of computing resources. Moreover, they usually require extra data storage capacity to accommodate multiple copies of information and/or extra computing resources that are not fully utilized, except for peak demand periods.

Therefore, there is a need for an effective query execution management in a data processing system providing an efficient computing workload balancing mechanism.

### SUMMARY OF THE INVENTION

The present invention is generally directed to a method, system and article of manufacture for query execution management in a data processing system and more particularly for scheduling execution of queries against one or more databases in a data processing system.

One embodiment provides a method for managing query execution in a data processing system. The method comprises providing at least one query execution schedule configured to schedule specific queries against a database in the data processing system, receiving a query against the database, and managing execution of the received query on the basis of the at least one query execution schedule.

Another embodiment provides a method for scheduling execution of a query against a database in a data processing system. The method comprises providing a plurality of query execution schedules, each query execution schedule defining query eligibility criteria identifying specific queries and a timeframe available for executing the specific queries, receiving a query against the database, determining, for the received query, a suitable query execution schedule on the basis of the query eligibility criteria of the plurality of query execution schedules, and scheduling execution of the received query against the database on the basis of the timeframe defined by the suitable query execution schedule.

Still another embodiment provides a method of providing a query execution schedule for scheduling execution of specific queries against a database in a data processing system. The method comprises defining query eligibility criteria identifying the specific queries to be scheduled by the query execution schedule, defining a timeframe available for executing the specific queries, and associating the query eligibility criteria and the timeframe with the query execution schedule.

Still another embodiment provides a computer readable medium containing a program which, when executed, performs a process for managing query execution in a data processing system. The process comprises receiving a query against a database in the data processing system, retrieving at least one query execution schedule configured to schedule specific queries against the database, and managing execution of the received query on the basis of the at least one query execution schedule.

Still another embodiment provides a computer readable medium containing a program which, when executed, performs a process for scheduling execution of a query against a database in a data processing system The process comprises receiving a query against the database, retrieving a plurality of query execution schedules, each query execution schedule defining query eligibility criteria identifying specific queries and a timeframe available for executing the specific queries, determining, for the received query, a suitable query execution schedule on the basis of the query eligibility criteria of the plurality of query execution schedules, and scheduling execution of the received query against the database on the basis of the timeframe defined by the suitable query execution schedule.

Still another embodiment provides a computer readable medium containing a program which, when executed, performs a process of providing a query execution schedule for scheduling execution of specific queries against a database in a data processing system. The process comprises defining query eligibility criteria identifying the specific queries to be scheduled by the query execution schedule, defining a timeframe available for executing the specific queries, and associating the query eligibility criteria and the timeframe with the query execution schedule.

Still another embodiment provides a data processing system comprising a database and a query manager residing in memory for managing query execution in the data processing system. The query manager is configured for receiving a query against the database, retrieving at least one query execution schedule configured to schedule specific queries against the database, and managing execution of the received query on the basis of the at least one query execution schedule.

Still another embodiment provides a data processing system comprising a database and a query manager residing in memory for scheduling execution of a query against the database. The query manager is configured for receiving a query against the database, retrieving a plurality of query execution schedules, each query execution schedule defining query eligibility criteria identifying specific queries and a timeframe available for executing the specific queries, determining, for the received query, a suitable query execution schedule on the basis of the query eligibility criteria of the plurality of query execution schedules, and scheduling execution of the received query against the database on the basis of the timeframe defined by the suitable query execution schedule.

Still another embodiment provides a data processing system comprising a database and a query execution schedule manager residing in memory for providing a query execution schedule for scheduling execution of specific queries against the database. The query execution schedule manager is configured for defining query eligibility criteria identifying the specific queries to be scheduled by the query execution schedule, defining a timeframe available for executing the specific queries, and associating the query eligibility criteria and the timeframe with the query execution schedule.

Still another embodiment provides a data structure for scheduling execution of specific queries against a database in a data processing system. The data structure resides in memory and comprises at least one query eligibility criterion field for identifying the specific queries to be scheduled and a timeframe field for identifying a period of time available for executing the specific queries.

### BRIEF DESCRIPTION OF THE DRAWINGS

So that the manner in which the above recited features of the present invention are attained can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with the invention;

FIG. 2A is a relational view of components implementing the invention;

FIGS. 2B and 2C are data structures according to one embodiment of the invention;

FIG. 3 is a flow chart illustrating query execution management in one embodiment;

FIG. 4 is a flow chart illustrating generation of query execution schedules in one embodiment;

FIG. 5 is a flow chart illustrating an embodiment of query execution scheduling;

FIG. 6 is a flow chart illustrating determination of an appropriate query execution schedule in one embodiment; and

FIG. 7 is a flow chart illustrating identification of an associated timeframe in one embodiment.

### DETAILED DESCRIPTION OF THE PREFERRED EMBODIMENTS

### INTRODUCTION

The present invention is generally directed to a method and article of manufacture for query execution management in a data processing system and more particularly to scheduling execution of queries against one or more databases in a data processing system. According to one aspect of the invention, the data processing system is a production environment, in which a data warehouse runs for its intended use in the day-by-day business of a company. The data warehouse includes one or more federated data sources. Each data source may represent a separate database.

In the production environment, queries are issued by an application or user against the one or more databases. The queries are scheduled for execution according to query execution schedules. Each query execution schedule specifies a period of time representing a timeframe in which specific queries can be executed against a particular database of the one or more databases. Each query execution schedule further specifies query eligibility criteria for identifying the specific queries that can be run within that timeframe.

In one embodiment, a query execution schedule is generated. To this end, query eligibility criteria and a timeframe are defined. The defined query eligibility criteria and the timeframe are associated with the query execution schedule.

In another embodiment, a plurality of query execution schedules is provided. Each query execution schedule has associated query eligibility criteria and a timeframe. When a query against a database is received, a suitable query execution schedule is determined for the received query. The suitable query execution schedule is determined from the plurality of query execution schedules on the basis of the associated query eligibility criteria. Execution of the received query against the database is then scheduled on the basis of the timeframe associated with the suitable query execution schedule.

### PREFERRED EMBODIMENTS

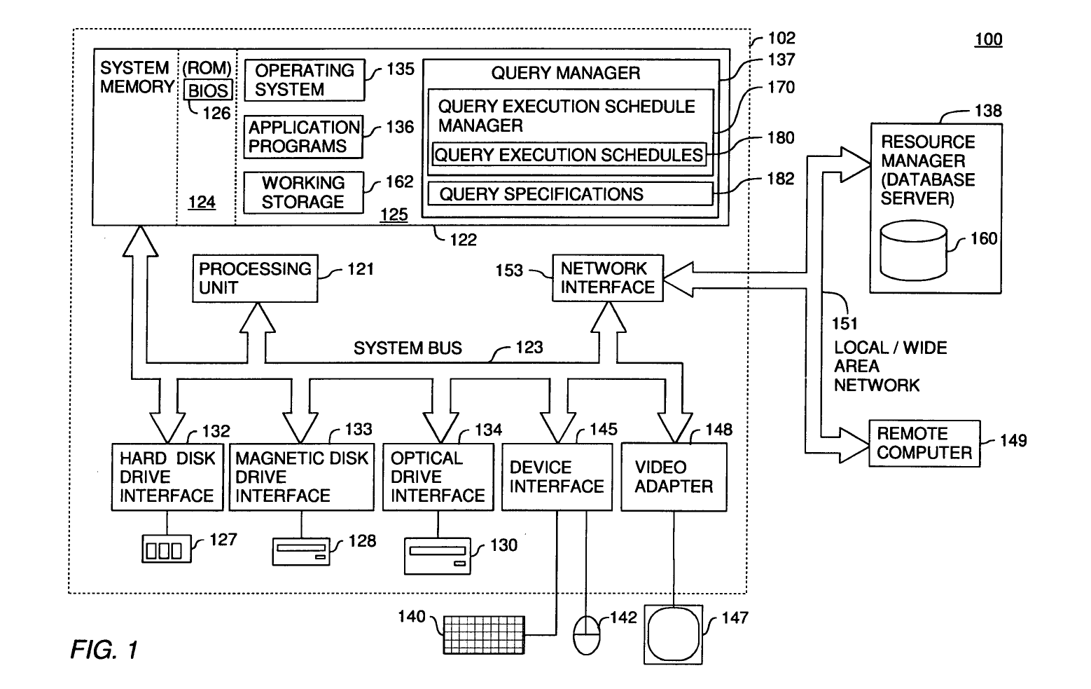

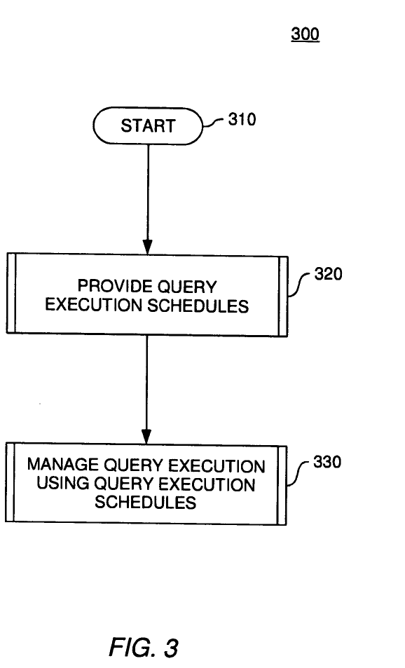

One embodiment of the invention is implemented as a program product for use with a computer system such as, for example, processing environment 100 shown in FIG. 1 and described below. The program(s) of the program product defines functions of the embodiments (including the methods described below with reference to FIGS. 3 to 7) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein by any suitable nomenclature, such as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Some embodiments of the present invention are described in the context of queries. However, embodiments within the scope of the invention are applicable to any data processing system in which it is desirable to manage concurrent execution of instructions for accessing data that is present in local or remote data sources. Furthermore, while some embodiments may refer to specific query languages like SQL, it should be understood that the present invention is not intended to be limited to such a specific query language. Instead, any known or unknown query language is contemplated.

FIG. 1 is a processing environment 100 generally comprising a computer or data processing system 102 communicating with a remote computer 149. Illustratively, the computer system 102 includes a processing unit 121, a system memory 122, and a system bus 123 that operatively couples various system components, including the system memory 122, to the processing unit 121. There may be only one or there may be more than one processing units 121, such that the processor of computer system 102 includes a single central processing unit (CPU), or a plurality of processing units, as in the case of a multiprocessor system.

The system bus 123 may be any of several types of bus structures including a memory bus or memory controller, a peripheral bus, and a local bus using any of a variety of bus architectures. The system memory 122 may also be referred to as simply the “memory”, and includes read only memory (ROM) 124 and random access memory (RAM) 125. A basic input/output system (BIOS) 126 stored in ROM 124 contains the basic routines that help to transfer information between elements within the computer system 102, such as during start-up. A portion of the system memory 122 is set aside as working storage 162. Illustratively, the working storage 162 is shown as a part of the random access memory 125. However, the working storage 162 may be established in any memory space and in particular in high-speed memory devices, such as cache memory. In other embodiments, working storage includes storage on devices such as hard disks.

The computer system 102 further includes a plurality of storage access devices, which may be configured with working storage. Such devices include a hard disk drive 127, a magnetic disk drive 128, and an optical disk drive 130 (e.g., a CD-ROM or DVD drive). The hard disk drive 127, magnetic disk drive 128, and optical disk drive 130 are connected to the system bus 123 by a hard disk drive interface 132, a magnetic disk drive interface 133, and an optical disk drive interface 134, respectively. The drives and their associated computer-readable media provide nonvolatile storage of computer-readable instructions, data structures, program modules and other data for the computer system 102. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the exemplary operating environment.

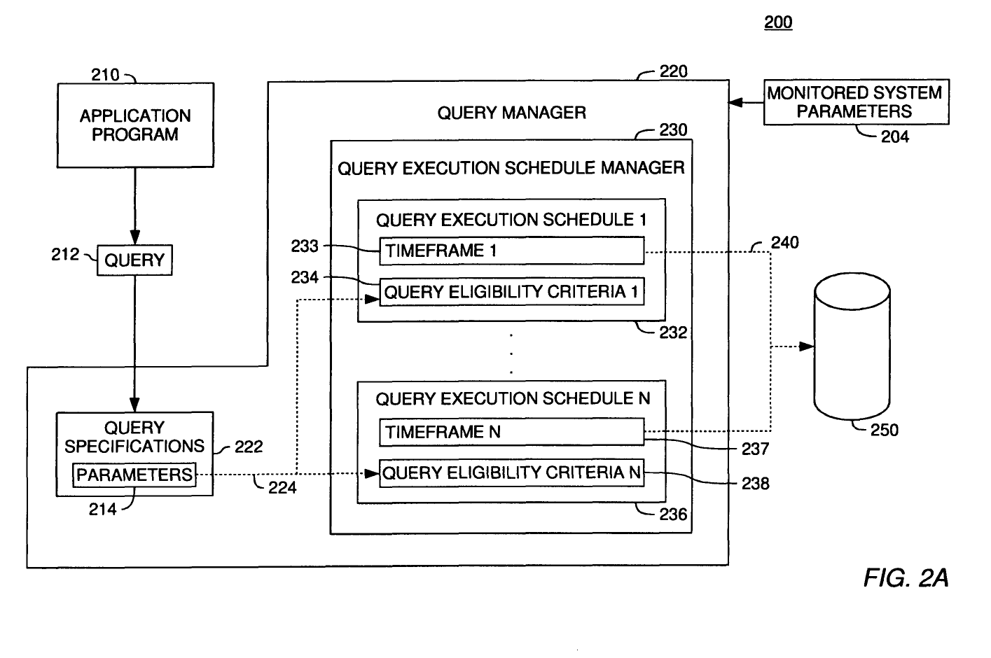

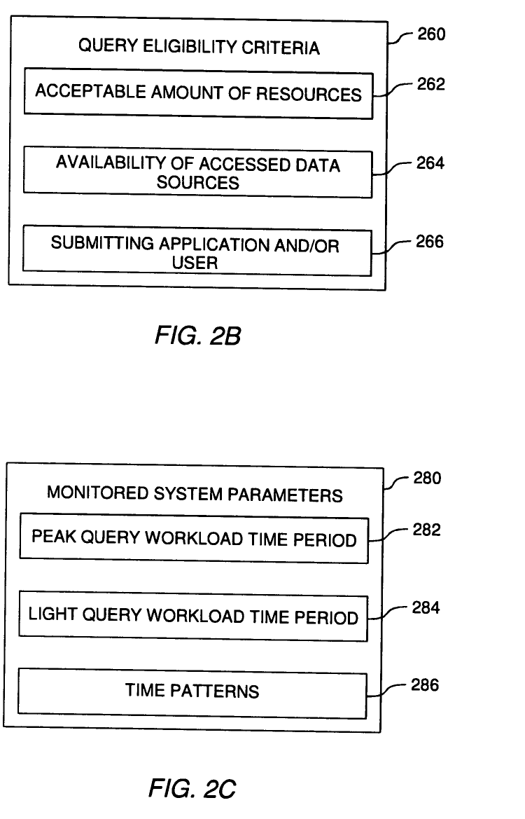

A number of program modules and data structures may be stored on the media readable hard disk drive 127, magnetic disk drive 128, optical disk drive 130, ROM 124, or RAM 125. Illustrative programs include an operating system 135, one or more application programs 136 and a query manager 137. In one embodiment, the query manager 137 schedules execution of queries against databases, such as database 160. More specifically, for a query received from an application 136, the query manager 137 determines query-specific parameters and stores the received query together with the query-specific parameters as query specifications 182. The query manager 137 uses the query-specific parameters to determine an appropriate query execution schedule from a plurality of query execution schedules 180 managed by a query execution schedule manager 170. The determined query execution schedule is used for scheduling the execution of the received query. The query manager 137 and its constituent functions are further described below with reference to FIG. 2.

A user may enter commands and information into the computer system 102 through input devices such as a keyboard 140 and a pointing device 142. These and other devices may be connected to the processing unit 121 through an interface 145 that is coupled to the system bus. Illustratively, the interface 145 is a serial port interface, but other interfaces, such as a parallel port or a universal serial bus (USB) are also contemplated. A monitor 147 or other type of display device is also connected to the system bus 123 via an interface, such as a video adapter 148. In addition to the monitor 147, the computer system 102 may include other peripheral devices such as speakers and printers.

The computer system 102 may operate in a networked environment using logical connections to one or more remote systems. These logical connections are achieved by a communication device coupled to or part of the computer system 102. The logical connections depicted in FIG. 1 are represented by a network connection 151 and may include a local-area network (LAN) and a wide-area network (WAN). Such networking environments are commonplace in office networks, enterprise-wide computer networks, intranets and the Internet, which are all types of networks. In one embodiment, the network connection 151 is wireless.

The computer system 102 is connected to the network 151 through a network interface or adapter 153, which is one type of communications device. When used in a WAN-networking environment, the computer system 102 may include a modem, or any other type of communications device for establishing communications over the wide area network, such as the Internet. In a networked environment, program modules depicted relative to the computer system 102, or portions thereof, may be stored in the remote memory storage device. It should be appreciated that the network connections shown are exemplary and other means of and communications devices for establishing a communications link between the computers may be used.

Illustratively, the network connection 151 communicates the computer system 102 with a backend resource manager 138 and a remote computer 149 (representing any type of machine, e.g., workstation or personal digital assistant (PDA)). In general, the resource manager 138 may be a relational database, a messaging system, or any type of middleware which provides data management services that can be accessed by an application program 136. In a particular embodiment the backend resource manager 138 is a database server. As such, the database 160 is shown associated with the backend resource manager 138. Although shown separately from the computer system 102, in another embodiment the backend resource manager 138 is a part of the computer system 102. In a particular embodiment, the resource manager 138 is part of a relational database management system (RDBMS).

Referring now to FIG. 2A, an illustrative relational view 200 of a query manager 220 (e.g., query manager 137 of FIG. 1) and other components of the invention is shown. The query manager 220 receives a query 212 from a user and/or an application 210 (e.g., application program 136 of FIG. 1) for execution against one or more databases 250 (e.g., database 160 of FIG. 1). The query manager 220 schedules the received query 212 for execution on the basis of one or more query execution schedules 232, 236 (e.g., query execution schedules 180 of FIG. 1).

In the illustrated embodiment, the query manager 220 includes query specifications 222 and a query execution schedule manager 230. The query execution schedule manager 230 includes one or more query execution schedules. Illustratively, the query execution schedule manager 230 includes two query execution schedules, “QUERY EXECUTION SCHEDULE 1” 232 and “QUERY EXECUTION SCHEDULE N” 236. Each query execution schedule identifies a timeframe and query eligibility criteria. The timeframe defines a period of time in which specific queries can be executed. The query eligibility criteria define one or more criteria used to identify the specific queries. Illustratively, the query execution schedule “QUERY EXECUTION SCHEDULE 1” 232 includes a timeframe “TIMEFRAME 1” 233 and query eligibility criteria “QUERY ELIGIBILITY CRITERIA 1” 234. The query execution schedule “QUERY EXECUTION SCHEDULE N” 236 includes a timeframe “TIMEFRAME N” 237 and query eligibility criteria “QUERY ELIGIBILITY CRITERIA N” 238.

In one embodiment, the timeframe (e.g., 233 or 237) for a particular query execution schedule (e.g., 232 or 236) can be an explicit timeframe, e.g., between 12:00 a.m. and 5:00 a.m., Monday-Friday. In another embodiment, the timeframe can be derived based on system resource availability. According to one aspect of the invention, the system resource availability may indicate a period of time when system computing resource utilization is low (maybe below some threshold) or when system resources are available. According to another aspect of the invention, system resource availability is based on monitored system parameters 204. In this case, system resource availability describes a distribution of an amount of available/used computing resources in relation to computing workload. System resource availability may further describe an availability of accessible information. Thus, for instance, for a period of time where a required data source is available and the computing workload is expected to be low, a corresponding timeframe can be generated.

The query eligibility criteria (e.g., 234 or 238) are derived from the system resource availability and, thus, stated in terms of the amount of system resources needed by the specific queries for execution and/or in terms of the one or more databases (interchangeably referred to as the data sources) accessed by the specific queries. The query eligibility criteria may further be stated in terms of an application and/or user submitting the query. In one embodiment, only queries that match the query eligibility criteria can run during an associated timeframe. In another embodiment, such queries must run during the associated timeframe and other queries are not similarly restricted.

More specifically, the type of query eligibility criteria that could be specified with a query execution schedule (e.g., 232 or 236) may include criteria based on the amount of estimated computing resources needed to run the specific queries. For instance, International Business Machines' (IBM) DB2 database product provides for a concept of a “timeron” that is a metric estimating the amount of computing resources needed by a query. Accordingly, with IBM's DB2 a particular query execution schedule could allow queries to be executed on the basis of a range of timeron values. Furthermore, the query eligibility criteria can define an available computing resource threshold. In this case, if the estimated amount of computing resources needed to execute the received query 212 exceeds the predetermined threshold, the query 212 may be executed. Another type of query eligibility criteria that could be specified may include criteria based on one or more data sources being accessed by the specific queries. This would allow for scheduling a federated query, i.e., a query that accesses multiple distributed databases, for execution only when all of the data sources are supposed to be online. Accordingly, periods of times in which one or more data sources are known to be offline can be avoided. Another type of query eligibility criteria that could be specified may include criteria based on the application 210 or a user submitting the specific queries. For instance, a particular query execution schedule can be defined such that only certain users and/or applications can run queries anytime, while queries submitted by other users and/or applications would be deferred to run during specific periods of time, such as off-peak hours of the day.

Referring now to FIG. 2B, a data structure 260 is shown that illustrates query eligibility criteria “QUERY ELIGIBILITY CRITERIA” (e.g., query eligibility criteria 234 or 238 of FIG. 2A) in one embodiment. The data structure 260 includes a field 262 indicating a maximum allowable amount of estimated computing resources needed to run a received query (e.g., query 212 of FIG. 2A). The data structure 260 further includes a field 264 indicating availability of databases which are accessible by the received query. The data structure 260 further includes a field 266 indicating applications (e.g., application program 210 of FIG. 2A) and/or users which are eligible.

Referring now back to FIG. 2A, when the query manager 220 receives the query 212, one or more query-specific parameters 214 corresponding to the query eligibility criteria of the provided query execution schedule(s) are determined for/from the query. For instance, a resource parameter describing an estimation of required computing resources for execution of the query, one or more data source parameters describing one or more data sources accessed during execution of the query and/or one or more query issuing parameters describing a user and/or an application issuing the query can be determined. In one embodiment, the query manager 220 stores the received query 212 together with the determined query-specific parameters 214 as a query specification. Illustratively, the query specification is stored with a plurality of query specifications 222.

The query manager 220 compares the determined query-specific parameters with the query eligibility criteria of the provided query execution schedule(s) to identify a suitable query execution schedule for execution of the query. If the timeframe of the suitable query execution schedule is currently elapsing, the query may be executed immediately. Otherwise the query will be queued for execution when the timeframe of the suitable query execution schedule is reached. In the illustrated embodiment, as indicated by the dashed arrow 224, the query-specific parameters 214 are compared with the query eligibility criteria “QUERY ELIGIBILITY CRITERIA 1” 234 and the query eligibility criteria “QUERY ELIGIBILITY CRITERIA N” 238. In one embodiment, the received query 212 is associated with the query execution schedule that has matching query eligibility criteria. The timeframe of the associated query execution schedule indicates the time, or time period, when the received query 212 is to be executed against the one or more databases 250. Illustratively, as indicated by dashed arrow 240, the received query 212 is executed against the database 250 according to one of the timeframes “TIMEFRAME 1” 233 or “TIMEFRAME N” 237.

In one embodiment, the query-specific parameters 214 of the received query 212 may match the query eligibility criteria of more than one query execution schedule. In this case, the timeframe for execution of the received query 212 against the database 250 can be determined as the intersection of the corresponding query execution schedules. The intersection thus represents an enabled query timeframe.

For example, a user “USER U” submits a query that requires an estimated amount “X” of computing resources and involves two data sources, “A” and “B”. Assume that four query execution schedules are provided as shown in Table 1 below:

TABLE I
EXEMPLARY PROVIDED QUERY EXECUTION SCHEDULES

1. Schedule (user = ‘USER U’): 19:00-05:00
2. Schedule (resource >= ‘X’): 01:00-06:00
3. Schedule (data source = ‘A’): 02:00-23:00
4. Schedule (data source = ‘B’): 04:00-02:00

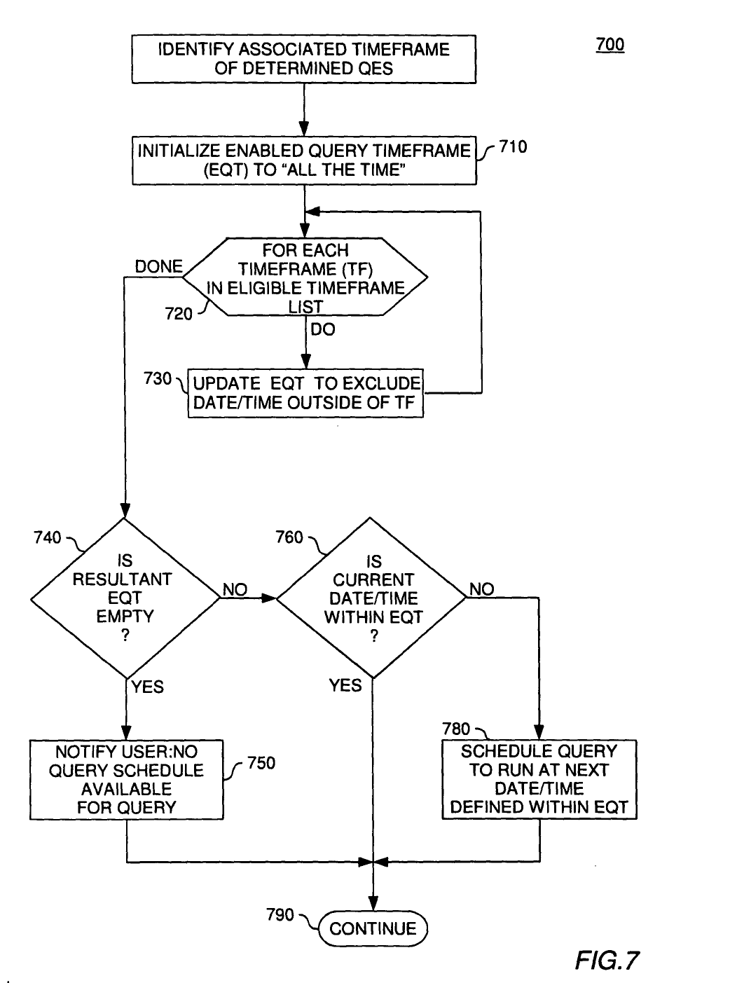

The first schedule defines a timeframe “19:00-05:00” and an exemplary query eligibility criterion “user=‘USER U’”. In other words, the first schedule indicates that queries issued by a specific user USER U (or a correspondingly named group of users) are allowed to be executed from 19:00 through 05:00. It should be appreciated that the first schedule is intended to influence when queries from USER U are scheduled, but will not have an influence on the queries from other users. Similarly, the second schedule defines a timeframe for queries that require an estimated amount of computing resources that is equal to or superior to ‘X’, the third query defines a timeframe for queries that access data source ‘A’, and the fourth query defines a timeframe for queries that access data source ‘B’. As the query submitted from “USER U” fulfills the query execution criteria of all provided query execution schedules, the resultant timeframe for execution of the query would be the intersection of the timeframes of all query execution schedules listed in Table 1 In other words, the query submitted from “USER U” will be scheduled for execution in the enabled query timeframe of 04:00-05:00. Determination of an enabled query timeframe in one embodiment is described in more detail below with reference to FIG. 7.

In one embodiment, the query eligibility criteria are statically determined, for instance, by a user or a database administrator. Determination of the query eligibility criteria can be based on the monitored system parameters 204. In another embodiment, one or more query execution schedules can be automatically generated via an analysis of the monitored system parameters 204. Furthermore, based on the monitored system parameters 204 the query execution schedules 232, 236 can be dynamically adapted, thus providing a self-optimizing query manager.

Referring now to FIG. 2C, a data structure 280 is shown that illustrates monitored system parameters “MONITORED SYSTEM PARAMETERS” (e.g., monitored system parameters 204 of FIG. 2A) in one embodiment. The data structure 280 includes a field 282 indicating one or more peak query workload time periods. The one or more peak query workload time periods form a pattern of peak workload periods. Using this pattern, future workload peaks could be predicted. On the basis of the prediction, query execution schedules can be generated such that the peak time periods are avoided and execution of corresponding queries is deferred until a time period when the workload is not so great. For example, an analysis of queries executed during the determined peak time periods can be performed. Thus, the top n% of queries contributing to the peak load during the determined peak time periods can be identified. If, for instance, each of these queries requires an amount of computing resources that is greater than X, a query execution schedule can be identified having a query eligibility criterion that defers execution of such queries until after these peak time periods. Thus, execution of computing resource intensive queries can be avoided during the determined peak time periods.

The data structure 280 further includes a field 284 indicating light query workload time periods. Light query workload time periods are time periods, during which the fewest computing resources are engaged in servicing query execution requests. In one embodiment, light query workload time periods may be determined as time periods in which the query workload does not exceed a predetermined threshold. The predetermined threshold may be user-determined or automatically determined by the data processing system on the basis of some statistical analysis. The one or more light query workload time periods form a pattern of light workload periods. On the basis of this pattern, query eligibility criteria associated with light time periods can be created or adjusted to allow additional query workload to run when computing resources are plentifully available.

The data structure 280 further includes a field 286 indicating time patterns. The time patterns define patterns in time when a given remote data source is inaccessible. These patterns in time can be determined on the basis of failures in query execution against a particular data source, for example by an examination of federated query logs. From the failures, time periods can be determined that indicate when the particular data source is expected to be offline. Thus, a query execution schedule can be generated having query eligibility criteria that prevent queries against that particular data source during the determined offline time periods.

It should be noted that the monitored system parameters illustrated in FIG. 2C are merely illustrative and not intended to be exhaustive. One skilled in the art will recognize that other system parameters may be monitored for a suitable generation of query execution schedules. For instance, any statistics obtained from a corresponding database management system and/or federated query logs may be appropriate. Another example is a maintenance schedule for a given database that would indicate when the database was scheduled to be offline for backup purposes. This information can be examined and query execution schedules can be generated to direct query workload around this scheduled outage.

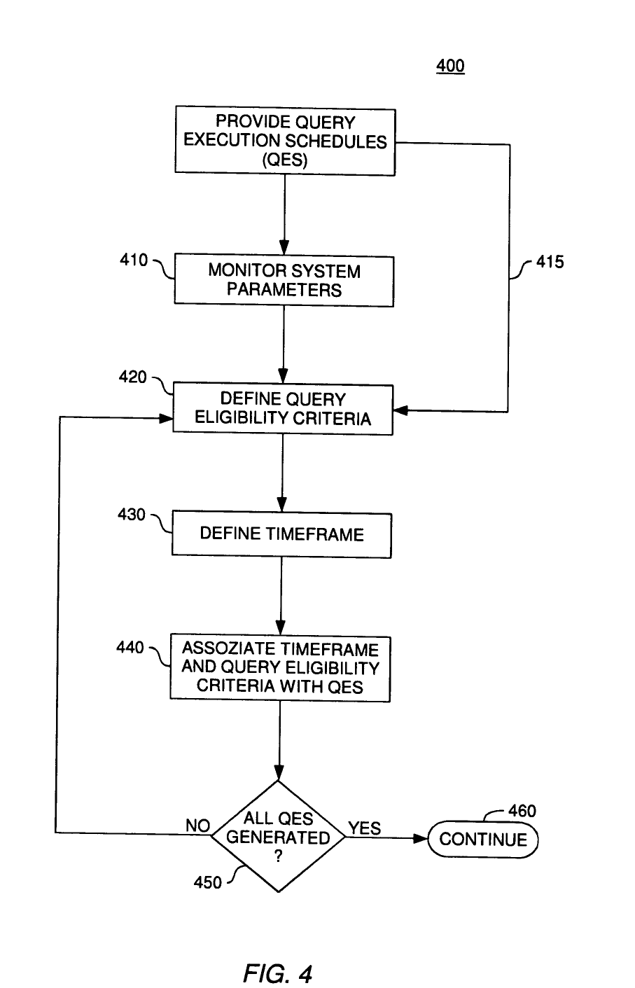

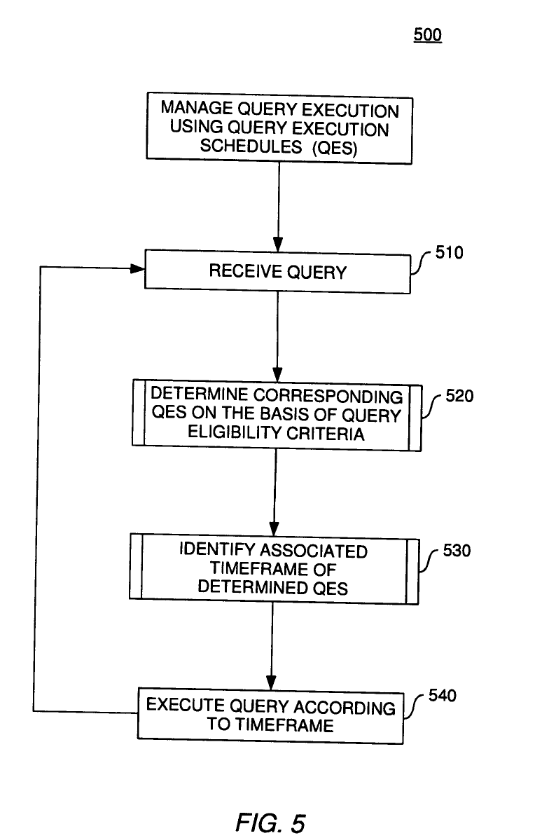

Referring now to FIG. 3, an embodiment of a method 300 for managing query execution in a data processing system (e.g., data processing system 102) is shown. The method 300 starts at step 310. At step 320, at least one query execution schedule (e.g., query execution schedule 232, 236 of FIG. 2A) is provided. The at least one query execution schedule is configured to schedule specific queries against a database (e.g., database 250 of FIG. 2A) in the data processing system. Generation of query execution schedules in one embodiment is described below with reference to FIG. 4. At step 330, when a query (e.g., query 212 of FIG. 2A) against the database is received, execution of the received query is managed. The query execution is managed on the basis of the at least one query execution schedule. Query management execution in one embodiment is described below with reference to FIG. 5.

It should be noted that the order of execution illustrated in FIG. 3 has merely been chosen for the purpose of explanation. However, it should be noted that other implementations for practicing the query execution management according to aspects of the invention are possible. For instance, in one embodiment steps 320 and 330 may be performed concurrently. In this embodiment, the provided query execution schedules may be dynamically updated while queries are executed against the one or more databases in the data processing system. The dynamic updates can be performed on the basis of monitored system parameters (e.g., monitored system parameters 204 of FIG. 2A).

Referring now to FIG. 4, one embodiment of a method 400 for generating and providing query execution schedules (e.g., query execution schedules 232, 236 of FIG. 2A) according to step 320 of FIG. 3 is shown. Method 400 starts with step 410. In step 410, system parameters of the data processing system are monitored. In one embodiment, the monitored system parameters (e.g., monitored system parameters 204) form a basis for subsequent steps 420 and/or 430. In this case, the query execution schedules may either be provided statically or updated dynamically on the basis of the monitored system parameters. Alternatively, as indicated by arrow 415, if monitoring of the system parameters is not required or desired for generation of the query execution schedules, step 410 may be bypassed. For instance, a database administrator may determine the system resource availability manually, e.g., according to the daily working hours in a company or a known availability of accessible data sources. In this case, the method 400 starts with step 420.

In step 420, query eligibility criteria (e.g., query eligibility criteria 234, 238 of FIG. 2A) for a particular query execution schedule are defined. In step 430, a timeframe for the particular query execution schedule is defined. It should be noted that, while step 430 is shown subsequent to step 420, both steps may be interchanged or performed concurrently. For instance, the system resource availability, derived from monitored system parameters or not, may indicate a peak query workload time period every day from 14:00 to 16:00 due to an increased research activity caused by specific user(s). Thus, the timeframe may be determined as any period of time except 14:00 to 16:00 with associated query eligibility criteria that would prevent the specific user(s) from running research-type queries in this timeframe.

In step 440, the timeframe defined at step 430 and the query eligibility criteria defined at step 420 are associated with the particular query execution schedule. In step 450, a determination is made as to whether all query execution schedules have been generated or not. This determination may involve an examination of the system resource availability. For instance, it may be determined whether further peak query workload time periods exist, for which no query execution schedule has yet been generated. If it is determined, at step 450, that other query execution schedules need to be generated, processing returns to step 420. If all required query execution schedules have been generated, processing continues at step 460, i.e., with step 330 of FIG. 3.

Referring now to FIG. 5, one embodiment of a method 500 for managing query execution (according to step 330 of FIG. 3) is shown. Method 500 starts with step 510. In step 510, a query (e.g., query 212 of FIG. 2A) is received. In step 520, a suitable query execution schedule is determined for the received query. In one embodiment, the suitable query execution schedule is determined from a plurality of provided query execution schedules (e.g., query execution schedule 232, 236). The plurality of query execution schedules can be provided according to method 400 illustrated in FIG. 4.

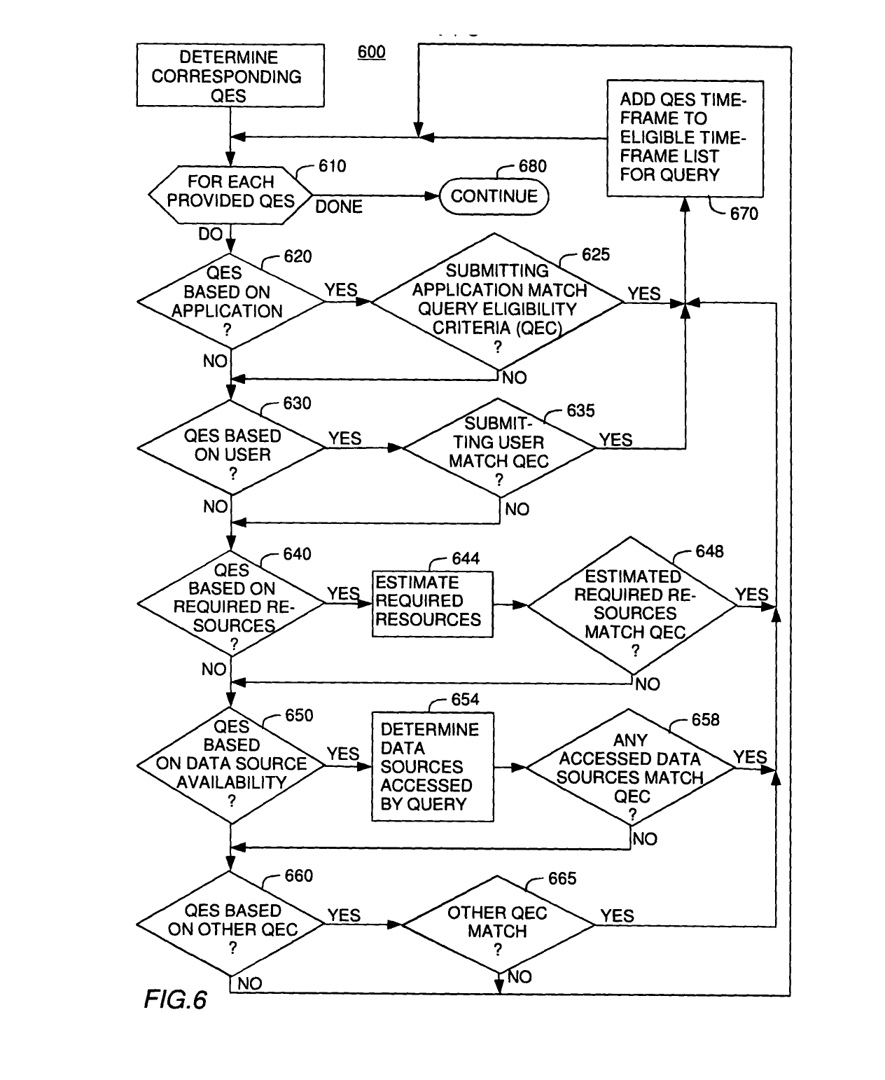

The suitable query execution schedule is determined on the basis of query eligibility criteria (e.g., query eligibility criteria 234, 238 of FIG. 2A) associated with the plurality of provided query execution schedules. To this end, query-specific parameters are determined for the received query and compared to the query eligibility criteria of each query execution schedule of the plurality of provided query execution schedules. If the query eligibility criteria of a corresponding query execution schedule are satisfied, the corresponding query execution schedule is considered as being suitable. Thus, it is contemplated that multiple query execution schedules may be considered as being suitable for the received query. Determination of the suitable query execution schedule is described in more detail below with reference to FIG. 6.

In step 530, for each suitable query execution schedule an associated timeframe is identified. In one embodiment, identification of the associated timeframe(s) is performed using a list of eligible timeframes, as described in more detail below with reference to FIG. 7.

On the basis of the identified timeframe(s), an appropriate period of time for execution of the received query is determined. If only one query execution schedule is considered as being suitable, the appropriate period of time corresponds to the timeframe identified from the single suitable query execution schedule. If two or more query execution schedules are considered as being suitable, determination of the appropriate period of time can be performed as described above with respect to Table 1.

In step 540, execution of the received query against the database is scheduled according to the appropriate period of time. The method 500 then returns to step 510. Thus, steps 510 to 540 form a loop which is executed for each received query.

Referring now to FIG. 6, one embodiment of a method 600 for determining a corresponding query execution schedule on the basis of query eligibility criteria (according to step 520 of FIG. 5) is shown. The corresponding query execution schedule is determined from a plurality of provided query execution schedules (e.g., query execution schedules 180 of FIG. 1).

Method 600 starts with step 610. In step 610, a query execution schedule is selected from the plurality of provided query execution schedules. In step 620, it is determined whether the selected query execution schedule is based on one or more applications (e.g., application 210 of FIG. 2A) submitting a query (e.g., query 212 of FIG. 2A). In other words, in step 620 it is determined whether the selected query execution schedule defines query eligibility criteria based on applications that are allowed to submit queries. If it is determined that the selected query execution schedule is not based on one or more applications, processing continues at step 630. In step 625, if the selected query execution schedule is based on one or more applications, it is determined whether the application that submitted the received query matches the query eligibility criteria. In one embodiment, this determination can be made on the basis of a query issuing parameter stored with a query specification (e.g., query specification 180 of FIG. 1) corresponding to the received query. If a match is detected, processing continues at step 670. If no match is detected in step 625, processing continues at step 630.

In step 630, it is determined whether the selected query execution schedule is based on one or more users submitting a query. In other words, in step 630 it is determined whether the selected query execution schedule specifies query eligibility criteria based on users that are allowed to submit queries. If it is determined that the selected query execution schedule is not based on one or more users, processing continues at step 640. In step 635, if the selected query execution schedule is based on one or more users, it is determined whether the user that submitted the received query matches the query eligibility criteria. In one embodiment, this determination can be made on the basis of the query issuing parameter stored with the query specification. If a match is detected, processing continues at step 670. If no match is detected in step 635, processing continues at step 640.

In step 640, it is determined whether the selected query execution schedule is based on an amount of estimated computing resources. In other words, in step 640 it is determined whether the selected query execution schedule specifies query eligibility criteria based on the amount of estimated computing resources needed to run the received query. If it is determined that the selected query execution schedule is not based on the amount of estimated computing resources, processing continues at step 650. In step 644, if the selected query execution schedule is based on the amount of estimated computing resources, the estimated amount is determined for the received query. In one embodiment, determination of the estimated amount may consist in retrieving the estimated amount from a resource parameter stored with the query specification. At step 648, it is determined whether the determined estimated amount matches the query eligibility criteria. If a match is detected, processing continues at step 670. If no match is detected in step 648, processing continues at step 650.

In step 650, it is determined whether the selected query execution schedule is based on one or more data sources being accessed by the query. In other words, in step 650 it is determined whether the selected query execution schedule specifies query eligibility criteria based on an availability of data sources accessed by the received query. If it is determined that the selected query execution schedule is not based on the availability of data sources, processing continues at step 660. In step 654, if the selected query execution schedule is based on the availability of data sources, the one or more data sources that are accessed by the received query are determined from the received query. In one embodiment, determination of the accessed data sources may consist in retrieving the accessed data sources from a data source parameter stored with the query specification. At step 658, it is determined whether the determined accessed data source(s) match the query eligibility criteria. If a match is detected, processing continues at step 670. If no match is detected in step 658, processing continues at step 660.

In step 660, it is determined whether the selected query execution schedule is based on other criteria. In other words, in step 660 it is determined whether the selected query execution schedule specifies query eligibility criteria based on other criteria suitable to determine whether the received query is eligible. It should be noted that step 660 (and subsequent step 665) are intended to illustrate that the query eligibility criteria are not limited to the embodiments described above. Instead, any query eligibility criteria that are suitable to define eligible queries are contemplated. If it is determined, in step 660, that the selected query execution schedule is not based on other criteria, processing returns to step 610. In step 665, if the selected query execution schedule is based on other criteria, it is determined whether the received query matches the other query eligibility criteria. If a match is detected, processing continues at step 670. If no match is detected in step 665, processing continues at step 610.

In step 670, the timeframe of the selected query execution schedule is located and added to a list of eligible timeframes for the received query. If no list of eligible timeframes exists for the received query, a list is created. Processing then continues at step 610.

In step 610, a next query execution schedule is selected from the plurality of provided query execution schedules. The above described processing, i.e., steps 620 to 670 are then repeated for the next query execution schedule. Thus, steps 610 to 670 form a loop which is executed for all query execution schedules from the plurality of provided query execution schedules. If all query execution schedules have been processed, processing continues with step 680, i.e., with step 530 of FIG. 5.

Referring now to FIG. 7, one embodiment of a method 700 for identification of the associated timeframe(s) (according to step 530 of FIG. 5) is shown. The identified timeframes are used to determine an appropriate period of time for execution of the received query. Illustratively, the associated timeframes are identified from a list of eligible timeframes.

Method 700 starts at step 710, where an enabled query timeframe (EQT) is created for the received query. Initially, the EQT is set to “all the time”. In other words, the EQT is initially set to allow execution of the received query at any time. In step 720, an eligible timeframe is selected from the list of eligible timeframes. In step 730, the EQT is updated to exclude dates/times outside of the selected eligible timeframe. Thus, a current timeframe is generated which represents an intersection of a previous timeframe and the selected eligible timeframe. Processing then continues at step 720.

The steps 720 and 730 are performed for each eligible timeframe from the list of eligible timeframes. When all eligible timeframes have been processed, processing continues at step 740.

In step 740, it is determined whether the resultant EQT is empty. If the resultant EQT is not empty, processing continues at step 760. If, however, the resultant EQT is empty, no timeframe can be determined for execution of the received query. Therefore, in step 750, the user (or application) submitting the received query is notified that no query execution schedule is available for the received query. Notification of the user can be performed using any suitable notification means. Processing then continues at step 790. In step 790, processing continues according to the method 500 of FIG. 5, i.e., at step 540. In one embodiment, as no query execution schedule is available for the received query, the received query is immediately executed at step 540. In another embodiment, the received query may be put on hold, e.g., until a light query workload time period is detected.

In step 760, it is determined whether the current date/time is within the resultant EQT. If the current date/time is not within the resultant EQT, processing continues at step 780. If the current date/time is within the resultant EQT, processing continues at step 790 (i.e. at step 540 of FIG. 5) where the received query is immediately executed.

In step 780, the received query is scheduled for running according to the resultant EQT. Processing then continues at step 790 (i.e. at step 540 of FIG. 5) where the received query is executed at the next date/time defined within the resultant EQT.

In various embodiments, the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features and advantages are merely illustrative and, unless explicitly present, are not considered elements or limitations of the appended claims.

Embodiments of the invention make much more efficient use of available computing resources. Thus, the same data environment can now be used by a variety of applications and a wide range of query applications. For instance, query execution schedules can be provided to restrict large, resource intensive queries to off hours of a company. Thus, these large queries will not compete with production applications which are active during the operating hours of the company. Furthermore, query execution schedules for smaller, short running queries can have a large timeframe allowing these queries to effectively run when submitted. Thus, good response times can be guaranteed for these short queries. Furthermore, query execution schedules for federated queries against data sources that are off-line from time-to-time can be sent to accommodate scheduled times when the data sources are off-line. Thus, queries against the data sources could be put on hold until the query execution schedule is ready for execution when the data sources are known to be online.

In another aspect, query execution schedules can be derived from information, such as monitored system parameters, and dynamically updated to automatically move resource intensive workload to off-peak time periods. Furthermore, query execution schedules can be dynamically updated to automatically anticipate time periods when a given data source is off-line.

In another aspect, excluding query execution schedules can be defined. An excluding query execution schedule would be defined as a period of time and a set of criteria that would identify specific queries that would be excluded from running during the defined period of time. While these excluding query execution schedules achieve the same effect as the query execution schedules described above, it may be easier and thus more user-friendly in some cases to state criteria for queries that should not be allowed to run during a particular period of time.

Furthermore, embodiments of the invention can be implemented in a framework for logically viewing physical data. Such a framework is disclosed in commonly assigned U.S. patent application Ser. No. 10/083,075 (the '075 application), filed Feb. 22, 2002 entitled “Improved Application Flexibility Through Database Schema and Query Abstraction”, and is hereby incorporated by reference in its entirety. The framework of the '075 application provides a requesting entity (i.e., an end-user or application) with an abstract representation of physical data. In other words, the framework of the '075 application provides the requesting entity with an abstract data model that logically describes an underlying physical data structure. In this way, the requesting entity is decoupled from the underlying physical data to be accessed. Logical queries based on the framework can be constructed without regard for the makeup of the physical data. Further, changes to the physical data do not necessitate changes to applications accessing the physical data. Accordingly, embodiments of the invention may be practiced as such in the framework of the '075 application or directed towards logical query execution schedules.

While the foregoing is directed to embodiments of the present invention, other and further embodiments of the invention may be devised without departing from the basic scope thereof, and the scope thereof is determined by the claims that follow.

1. A method for managing query execution in a data processing system, comprising:
providing at least one query execution schedule configured to schedule specific queries against a database in the data processing system;
receiving a query against the database; and
managing execution of the received query on the basis of the at least one query execution schedule.

2. The method of claim 1, wherein managing the execution of the received query comprises:
determining, whether the received query is a specific query; and
if so, scheduling execution of the received query using the query execution schedule.

3. The method of claim 1, wherein the at least one query execution schedule defines query eligibility criteria identifying the specific queries and a timeframe available for executing the specific queries.

4. The method of claim 3, wherein the query eligibility criteria comprise at least one of:
an estimated amount of resources required for execution of the specific queries;
an availability of data sources accessed by the specific queries;
a user submitting the specific queries; and
an application submitting the specific queries.

5. The method of claim 1, wherein the at least one query execution schedule is statically defined by a human operator.

6. The method of claim 1, wherein the at least one query execution schedule is dynamically defined by the data processing system on the basis of monitored system parameters.

7. A method for scheduling execution of a query against a database in a data processing system, comprising:
providing a plurality of query execution schedules, each query execution schedule defining query eligibility criteria identifying specific queries and a timeframe available for executing the specific queries;
receiving a query against the database;
determining, for the received query, a suitable query execution schedule on the basis of the query eligibility criteria of the plurality of query execution schedules; and
scheduling execution of the received query against the database on the basis of the timeframe defined by the suitable query execution schedule.

8. The method of claim 7, wherein a plurality of suitable query execution schedules is determined and wherein the scheduling comprises:
determining an intersection of the timeframes of the plurality of suitable query execution schedules; and
scheduling execution of the received query against the database on the basis of the determined intersection.

9. The method of claim 7, wherein a plurality of suitable query execution schedules is determined and wherein the scheduling comprises:
determining an intersection of the timeframes of the plurality of suitable query execution schedules;
determining whether the intersection is empty or not; and
if the intersection is not empty, scheduling execution of the received query against the database on the basis of the determined intersection; and
if the intersection is empty, notifying a user.

10. The method of claim 7, wherein the query eligibility criteria comprise at least one of:
an estimated amount of resources required for execution of the specific queries;
an availability of data sources accessed by the specific queries;
a user submitting the specific queries; and
an application submitting the specific queries.

11. The method of claim 7, wherein the plurality of query execution schedules is statically defined by a human operator.

12. The method of claim 7, wherein at least one of the plurality of query execution schedules is dynamically defined by the data processing system on the basis of monitored system parameters.

13. The method of claim 12, wherein the monitored system parameters comprise at least one of:
a peak query workload time period;
a light query workload time period; and
a time pattern indicating availability of the database.

14. The method of claim 13, wherein the database includes distributed data sources and wherein a separate time pattern is provided for each distributed data source, the separate time pattern indicating availability of a corresponding distributed data source.

15. A method of providing a query execution schedule for scheduling execution of specific queries against a database in a data processing system, comprising:
defining query eligibility criteria identifying the specific queries to be scheduled by the query execution schedule;
defining a timeframe available for executing the specific queries; and
associating the query eligibility criteria and the timeframe with the query execution schedule.

16. The method of claim 15, wherein the query eligibility criteria comprise at least one of:
an estimated amount of resources required for execution of the specific queries;
an availability of data sources accessed by the specific queries;
a user submitting the specific queries; and
an application submitting the specific queries.

17. The method of claim 15, further comprising:
monitoring system parameters of the data processing system; and
wherein the defining of the query eligibility criteria and the timeframe comprises:
dynamically defining the query eligibility criteria and the timeframe on the basis of the monitored system parameters.

18. The method of claim 17, wherein the monitored system parameters comprise at least one of:
a peak query workload time period;
a light query workload time period; and
a time pattern indicating availability of the database.

19. The method of claim 18, wherein the database includes distributed data sources and wherein a separate time pattern is provided for each distributed data source, the separate time pattern indicating availability of a corresponding distributed data source.

20. A computer readable medium containing a program which, when executed, performs a process for managing query execution in a data processing system, the process comprising:
receiving a query against a database in the data processing system;
retrieving at least one query execution schedule configured to schedule specific queries against the database; and
managing execution of the received query on the basis of the at least one query execution schedule.

21. The computer readable medium of claim 20, wherein managing the execution of the received query comprises:
determining, whether the received query is a specific query; and
if so, scheduling execution of the received query using the query execution schedule.

22. The computer readable medium of claim 20, wherein the at least one query execution schedule defines query eligibility criteria identifying the specific queries and a timeframe available for executing the specific queries.

23. The computer readable medium of claim 22, wherein the query eligibility criteria comprise at least one of:
an estimated amount of resources required for execution of the specific queries;
an availability of data sources accessed by the specific queries;
a user submitting the specific queries; and
an application submitting the specific queries.

24. The computer readable medium of claim 20, wherein the at least one query execution schedule is statically defined by a human operator.

25. The computer readable medium of claim 20, wherein the at least one query execution schedule is dynamically defined by the data processing system on the basis of monitored system parameters.

26. A computer readable medium containing a program which, when executed, performs a process for scheduling execution of a query against a database in a data processing system, the process comprising:
receiving a query against the database;
retrieving a plurality of query execution schedules, each query execution schedule defining query eligibility criteria identifying specific queries and a timeframe available for executing the specific queries;
determining, for the received query, a suitable query execution schedule on the basis of the query eligibility criteria of the plurality of query execution schedules; and
scheduling execution of the received query against the database on the basis of the timeframe defined by the suitable query execution schedule.

27. The computer readable medium of claim 26, wherein a plurality of suitable query execution schedules is determined and wherein the scheduling comprises:
determining an intersection of the timeframes of the plurality of suitable query execution schedules; and
scheduling execution of the received query against the database on the basis of the determined intersection.

28. The computer readable medium of claim 26, wherein a plurality of suitable query execution schedules is determined and wherein the scheduling comprises:
determining an intersection of the timeframes of the plurality of suitable query execution schedules;
determining whether the intersection is empty or not; and
if the intersection is not empty, scheduling execution of the received query against the database on the basis of the determined intersection; and
if the intersection is empty, notifying a user.

29. The computer readable medium of claim 26, wherein the query eligibility criteria comprise at least one of:
an estimated amount of resources required for execution of the specific queries;
an availability of data sources accessed by the specific queries;
a user submitting the specific queries; and
an application submitting the specific queries.

30. The computer readable medium of claim 26, wherein the plurality of query execution schedules is statically defined by a human operator.

31. The computer readable medium of claim 26, wherein at least one of the plurality of query execution schedules is dynamically defined by the data processing system on the basis of monitored system parameters.

32. The computer readable medium of claim 31, wherein the monitored system parameters comprise at least one of:
a peak query workload time period;
a light query workload time period; and
a time pattern indicating availability of the database.

33. The computer readable medium of claim 32, wherein the database includes distributed data sources and wherein a separate time pattern is generated for each distributed data source, the separate time pattern indicating availability of a corresponding distributed data source.

34. A computer readable medium containing a program which, when executed, performs a process of providing a query execution schedule for scheduling execution of specific queries against a database in a data processing system, the process comprising:
defining query eligibility criteria identifying the specific queries to be scheduled by the query execution schedule;
defining a timeframe available for executing the specific queries; and
associating the query eligibility criteria and the timeframe with the query execution schedule.

35. The computer readable medium of claim 34, wherein the query eligibility criteria comprise at least one of:
an estimated amount of resources required for execution of the specific queries;
an availability of data sources accessed by the specific queries;
a user submitting the specific queries; and
an application submitting the specific queries.

36. The computer readable medium of claim 34, further comprising:
monitoring system parameters of the data processing system; and
wherein the defining of the query eligibility criteria and the timeframe comprises:
dynamically defining the query eligibility criteria and the timeframe on the basis of the monitored system parameters.

37. The computer readable medium of claim 36, wherein the monitored system parameters comprise at least one of:
a peak query workload time period;
a light query workload time period; and
a time pattern indicating availability of the database.

38. The computer readable medium of claim 37, wherein the database includes distributed data sources and wherein a separate time pattern is provided for each distributed data source, the separate time pattern indicating availability of a corresponding distributed data source.

39. A data processing system comprising:
a database; and
a query manager residing in memory for managing query execution in the data processing system, the query manager being configured for:
receiving a query against the database;
retrieving at least one query execution schedule configured to schedule specific queries against the database; and
managing execution of the received query on the basis of the at least one query execution schedule.

40. A data processing system comprising:
a database; and
a query manager residing in memory for scheduling execution of a query against the database, the query manager being configured for:
receiving a query against the database;
retrieving a plurality of query execution schedules, each query execution schedule defining query eligibility criteria identifying specific queries and a timeframe available for executing the specific queries;
determining, for the received query, a suitable query execution schedule on the basis of the query eligibility criteria of the plurality of query execution schedules; and
scheduling execution of the received query against the database on the basis of the timeframe defined by the suitable query execution schedule.

41. A data processing system comprising:
a database; and
a query execution schedule manager residing in memory for providing a query execution schedule for scheduling execution of specific queries against the database, the query execution schedule manager being configured for:
defining query eligibility criteria identifying the specific queries to be scheduled by the query execution schedule;
defining a timeframe available for executing the specific queries; and
associating the query eligibility criteria and the timeframe with the query execution schedule.

42. A data structure for scheduling execution of specific queries against a database in a data processing system, the data structure residing in memory and comprising:
at least one query eligibility criterion field for identifying the specific queries to be scheduled; and
a timeframe field for identifying a period of time available for executing the specific queries.
